(19) United States
(12) Patent Application Publication
(10) Pub. No.: US 2003/0150946 A1
(43) Pub. Date: Aug. 14, 2003

(54) Fly fishing reel with a brake unit

(76) Inventor: Eugene Hong, Taichung City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/113,630

(22) Filed: Mar. 28, 2002

(30) Foreign Application Priority Data
Feb. 8, 2002 (TW) 091201774

(51) Int. Cl. A01K 89/015

(52) U.S. Cl. 242/289; 242/317

(57) ABSTRACT

A fly fishing reel includes a casing, a spool mounted rotatably in the casing, and a brake unit including a friction wall extending from the spool, a brake-mounting plate secured to the casing and formed with a plurality of retaining recesses, and a plurality of brake shoes securely and respectively mounted in the retaining recesses and in friction contact with the friction wall. The brake-mounting plate is spaced apart from the friction wall by a gap. Adjacent brake shoes are spaced apart from each other by a channel which is in spatial communication with the gap so as to permit removal of bits resulting from rubbing between the friction wall and the brake shoes upon rotation of the spool.

### BACKGROUND OF THE INVENTION

1. Field of the invention

This invention relates to a fly fishing reel, more particularly to a fly fishing reel with a brake unit.

2. Description of the related art

FIG. 1 illustrates a conventional fly fishing reel that includes a casing 1, a spool 2 mounted rotatably in the casing 1 for winding a fishing line (not shown) thereon, and a brake unit including a friction wall 202 extending radially from the spool 2, an annular brake shoe 4 which is mounted securely on the casing 1 via a mounting cap 3 and which is in frictional contact with the friction wall 202 for providing a resistance to the rotation of the spool 2 so as to slow down unwinding of the fishing line from the spool 2 by a pulling force when a fish is caught.

The conventional fly fishing reel is disadvantageous in that bits, which result from rubbing between the brake shoe 4 and the friction wall 202 upon rotation of the spool 2, tend to accumulate on the friction wall 202, which, in turn, adversely affects the braking effect of the brake unit. Moreover, a relatively large amount of heat, which results from the rubbing between the brake shoe 4 and the friction wall 202 upon rotation of the spool 2, tends to accumulate in the brake unit, which may shorten the service life of the same.

### SUMMARY OF THE INVENTION

Therefore, the object of the present invention is to provide a fly fishing reel with a brake unit that is capable of overcoming the aforesaid drawbacks.

According to the present invention, a fly fishing reel comprises: a casing; a spool mounted rotatably in the casing and including a shaft that is disposed in the casing, the spool being rotatable relative to the casing; and a brake unit. The brake unit includes a friction wall that projects radially and outwardly from the shaft, and a brake-mounting plate secured to the casing, confronting and parallel to the friction wall, and formed with a plurality of angularly spaced apart retaining recesses. A plurality of brake shoes are securely and respectively mounted in the retaining recesses in the brake-mounting plate and project outwardly therefrom to frictionally contact the friction wall so as to provide a resistance to rotation of the spool and so as to separate the brake-mounting plate from the friction wall by a gap. The brake shoes are spaced apart from one another to form a plurality of channels thereamong. The channels are in spatial communication with the gap so as to permit removal of bits, which result from rubbing between the brake shoes and the friction wall upon rotation of the spool, falling from the friction wall through the channels and into the gap.

### BRIEF DESCRIPTION OF THE DRAWINGS

In drawings which illustrate an embodiment of the invention,

FIG. 1 is an exploded perspective view of a conventional fly fishing reel;

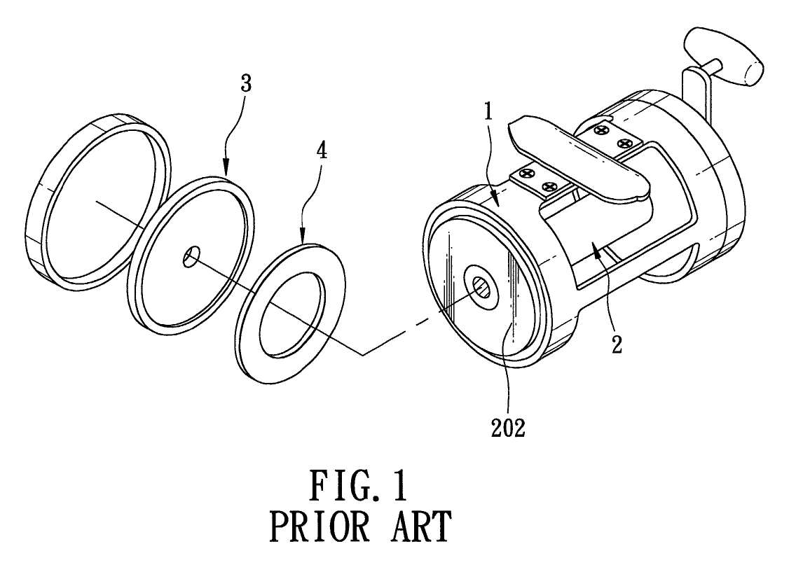

FIG. 2 is an exploded perspective view of a fly fishing reel embodying this invention; and

FIG. 3 is a schematic partly sectional view to illustrate a brake unit of the fly fishing reel of FIG. 2.

### DETAILED DESCRIPTION OF THE PREFERRED EMBODIMENT

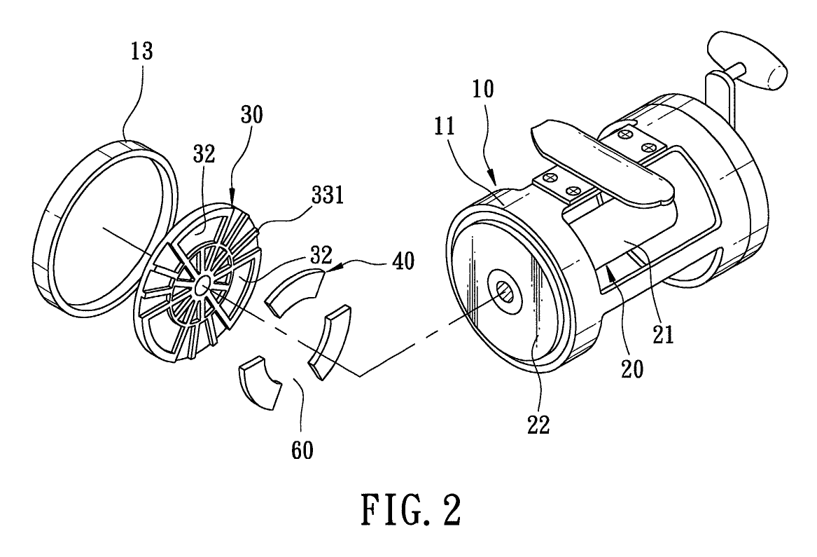

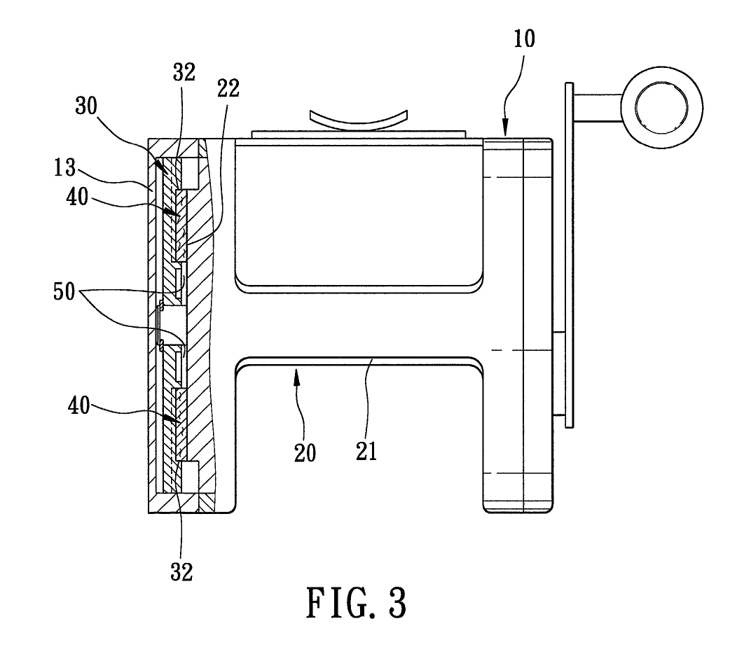

FIGS. 2 and 3 illustrate a fly fishing reel embodying this invention.

The fly fishing reel includes: a casing 10 having an open end 11; a spool 20 mounted rotatably in the casing 10 and including a shaft 21 that is disposed in the casing 10 and that extends through the open end 11, the spool 20 being rotatable relative to the casing 10; and a brake unit. The brake unit includes a friction wall 22 that projects radially and outwardly from the shaft 21 and that is disposed outwardly of the open end 11, and a brake-mounting plate 30 secured to the open end 11 of the casing 10 via a cap 13, confronting and parallel to the friction wall 22, and formed with a plurality of angularly spaced apart retaining recesses 32. A plurality of brake shoes 40 are securely and respectively mounted in the retaining recesses 32 in the brake-mounting plate 30 and project outwardly therefrom to frictionally contact the friction wall 22 so as to provide a resistance to rotation of the spool 20 and so as to separate the brake-mounting plate 30 from the friction wall 22 by a gap 50. The brake shoes 40 are spaced apart from one another to form a plurality of channels 60 thereamong. The channels 60 are in spatial communication with the gap 50 so as to permit removal of bits, which result from rubbing between the brake shoes 40 and the friction wall 22 upon rotation of the spool 20, falling from the friction wall 22 through the channels 60 and into the gap 50.

Each of the retaining recesses 32 is a segment of an annulus. Each of the brake shoes 40 is fittingly received in the respective one of the retaining recesses 32.

The brake-mounting plate 30 includes a plurality of ribs 331 projecting therefrom in a direction toward the friction wall 22, spaced apart from the friction wall 22, and extending in a radial direction relative to the shaft 21 so as to serve as a fan to facilitate the falling of the bits from the friction wall 22 and to enhance dissipation of heat which results from rubbing between the brake shoes 40 and the friction wall 22 upon rotation of the spool 20.

With the design of the brake-mounting plate 30 and the brake shoes 40, the aforesaid drawbacks as encountered in the prior art can be eliminated.

With the invention thus explained, it is apparent that various modifications and variations can be made without departing from the spirit of the present invention. It is therefore intended that the invention be limited only as recited in the appended claims.

I claim:

1. A fly fishing reel comprising:
a casing;
a spool mounted rotatably in said casing and including a shaft that is disposed in said casing, said spool being rotatable relative to said casing; and
a brake unit including
a friction wall that projects radially and outwardly from said shaft,
a brake-mounting plate secured to said casing, confronting and parallel to said friction wall, and formed with a plurality of angularly spaced apart retaining recesses, and
a plurality of brake shoes securely and respectively mounted in said retaining recesses in said brake-mounting plate and projecting outwardly therefrom to frictionally contact said friction wall so as to provide a resistance to rotation of said spool and so as to separate said brake-mounting plate from said friction wall by a gap, said brake shoes being spaced apart from one another to form a plurality of channels thereamong, said channels being in spatial communication with said gap so as to permit removal of bits, which result from rubbing between said brake shoes and said friction wall upon rotation of said spool, falling from said friction wall through said channels and into said gap.

2. The fly fishing reel of claim 1, wherein each of said retaining recesses is a segment of an annulus, each of said brake shoes being fittingly received in the respective one of said retaining recesses.

3. The fly fishing reel of claim 2, wherein said brake-mounting plate includes a plurality of ribs projecting therefrom in a direction toward said friction wall, spaced apart from said friction wall, and extending in a radial direction relative to said shaft so as to serve as a fan to facilitate the falling of the bits from said friction wall and to enhance dissipation of heat which results from rubbing between said brake shoes and said friction wall upon rotation of said spool.
